(19) United States
(12) Patent Application Publication
(10) Pub. No.: US 2010/0101291 A1
(43) Pub. Date: Apr. 29, 2010

(54) METHOD AND LUBRICANT APPLICATION DEVICE FOR REGULATING THE PLANARITY AND/OR ROUGHNESS OF A METAL STRIP

(76) Inventors: Hans-Peter Richter, Friedewald (DE); Hartmut Pawelski, Ratingen (DE)

Correspondence Address: FRIEDRICH KUEFFNER, 317 MADISON AVENUE, SUITE 910, NEW YORK, NY, 10017, US

(21) Appl. No.: 12/448,227

(22) PCT Filed: Nov. 12, 2007
(86) PCT No.: PCT/EP2007/009755

§ 371 Date: Jul. 20, 2009

(30) Foreign Application Priority Data
Jul. 12, 2007 (DE) 10 2007 032 485.7
Dec. 15, 2008 (DE) 10 2006 059 246.8

(51) Int. Cl. B21B 37/44; G06F 19/00

(52) U.S. Cl. 72/9.1; 72/236; 72/18.7; 700/154; 72/41

(57) ABSTRACT

A method and a lubricant application device for regulating the flatness and/or roughness of a metal strip in the outlet of a cold rolling stand by suitable metering of the amount of at least one lubricant per unit time applied to the metal strip in the inlet of the cold rolling stand. The applied amount of lubricant is metered in the form of a quantitative distribution over the width of the metal strip per unit time according to a detected control deviation between an actual and a desired flatness distribution over the width of the metal strip in the outlet of the cold rolling stand or a control deviation between an actual and a desired roughness distribution over the width of the metal strip in the outlet of the cold rolling stand or a combination of the two control deviations.

The invention relates to a method and a lubrication application device for regulating the flatness and/or roughness of a metal strip in the outlet of a cold rolling stand by suitable metering of the amount of at least one lubricant per unit time applied to the metal strip in the inlet of the cold rolling stand.

Such a method is described, for example, in the unpublished German patent application DE 10 2005 042 020 A1.

Starting from this technical teaching, it is the object of the invention to further develop a known method and a known lubricant application device for regulating the flatness and/or roughness of a metal strip in the outlet of a cold rolling stand such that the quality of the cold-rolled metal strip is further improved with regard to its flatness and/or its roughness.

This object is achieved by the method claimed in claim 1. This is characterised in that the applied amount of lubricant is metered in the form of a quantitative distribution over the width of the metal strip per unit time according to a detected control deviation between an actual and a desired flatness distribution over the width of the metal strip in the outlet of the cold rolling stand or a control deviation between an actual and a desired roughness distribution over the width of the metal strip in the outlet of the cold rolling stand or a combination of the two control deviations.

Unlike the technical teaching of the patent application cited initially, in the present patent application the application of a suitable amount of lubricant on the inlet side of the cold rolling stand is not made on a flat rate basis but distributed over the width of the metal strip. In this way, an individual amount of lubricant can advantageously be supplied for each section in the width direction of the metal strip, e.g. in the area of application of an individual nozzle in order to thereby adjust a predefined desired flatness in the respective width section.

The quantity of applied lubricant lies in a range of 1-20 ml/minute/100 mm width of the metal strip. The quantity is advantageously so low that it allows a specific change in the friction coefficient in the rolling gap of the cold rolling stand with regard to the desired flatness or desired roughness. The residual quantity of lubricant remaining on the metal strip in the outlet is minimal; it is advantageously so low that it need not be removed separately.

The invention provides that the residual content of lubrication on the metal strip on the outlet side of the cold rolling stand is advantageously measured. The residual content should on the one hand not fall below a predefined lower threshold because otherwise, there is a risk of rust formation on the metal strip since the lubricants typically used generally also have an anti-corrosion effect. On the other hand, the residual content of lubricant should not exceed an upper threshold value because otherwise there is a risk of a lateral profile of the metal strip on a roller table downstream of the cold rolling stand.

All the desired values predefined within the scope of the present invention are preferably based on empirical values from practice.

For carrying out the method according to the invention it is important that the lubricant is applied in a precisely metered quantity only on the inlet side. An additional application of coolant in the rolling gap on the inlet side of the cold rolling stand is not provided in the method according to the invention since this would falsify the specific adjustment of the friction coefficient in the rolling gap. In the method according to the invention, an application of coolant is therefore only provided, if at all, on the outlet side of the cold rolling stand or on the inlet side in such a manner that no coolant enters into the rolling gap.

A plurality of lubricants each having different friction-coefficient changing properties in the rolling gap is advantageously provided. Alternatively to a quantitative metering of a lubricant or a lubricant mixture, a precise friction coefficient in the rolling gap can then be adjusted by a correspondingly suitable mixing ratio of the various lubricants. The individual lubricants are advantageously only mixed within the individual nozzles of a nozzle beam; it is thereby possible to achieve a quite specific adjustment of the friction coefficient in the rolling gap for each width section of the metal strip. In addition, separate removal/storage of the unused lubricant is also possible.

In the present invention, the desired flatness or roughness of the metal strip is expressly not adjusted by varying the size of the rolling gap in the cold rolling stand; rather, the size of the rolling gap remains constant throughout the entire duration of treatment of the metal strip or is controlled by means of a separate control circuit which is not the subject matter of the present invention. In this case, for example, the difference between the speed of the metal strip in the inlet and in the outlet serves as a measure for the size of the rolling gap or the reduction in the strip.

The aforesaid object of the invention is furthermore achieved by a computer program, a data carrier with this computer program and a lubricant application device. The advantages of these solutions correspond to the advantages specified previously with reference to the method according to the invention.

A total of four figures are appended to the description, where

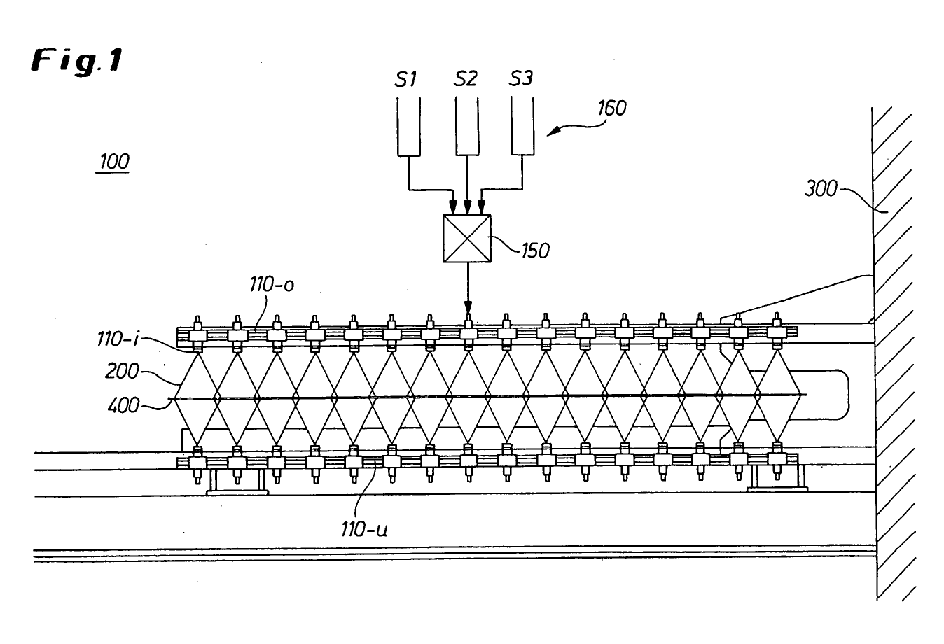

FIG. 1 is a cold rolling stand with a nozzle beam;

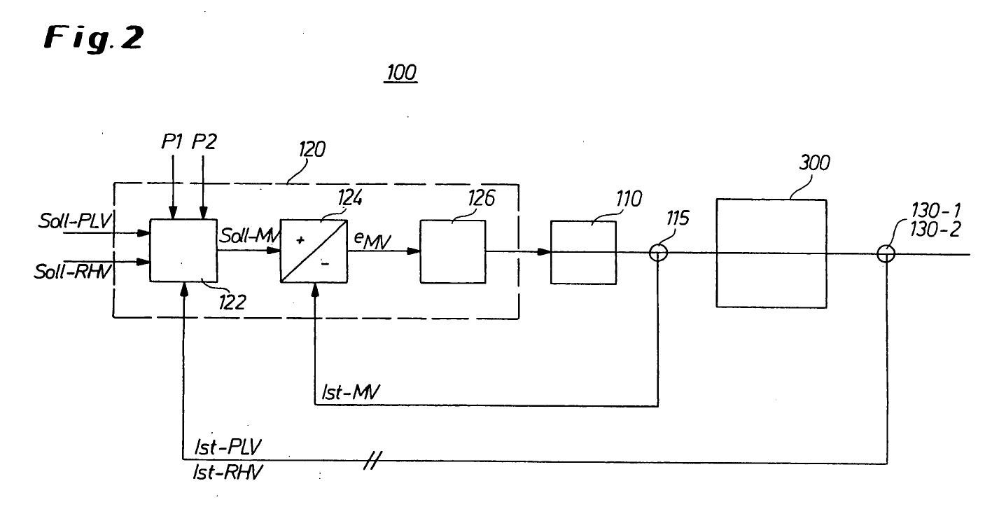

FIG. 2 shows the cascade control according to the invention; and

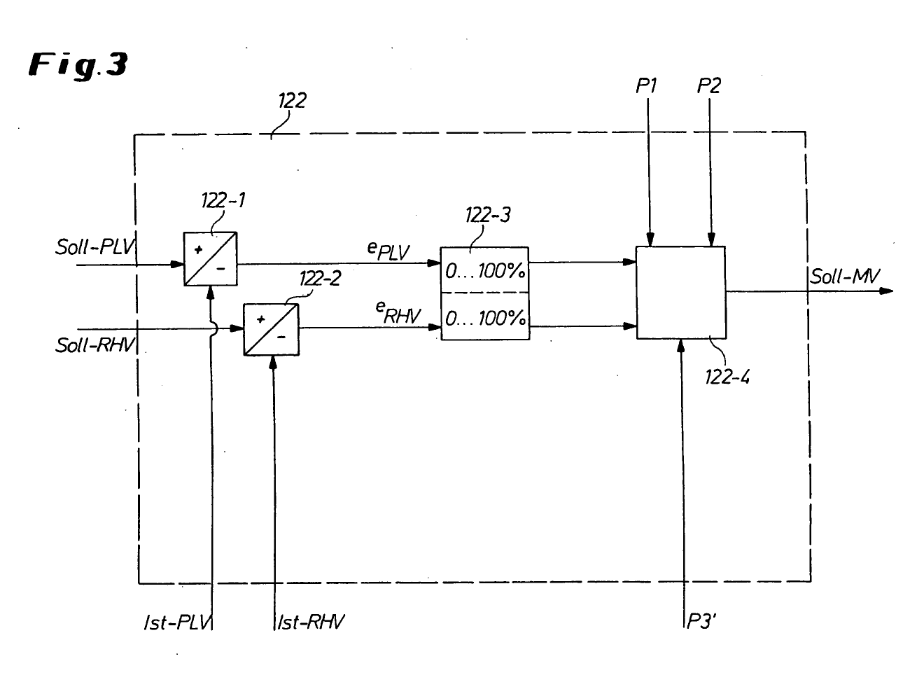

FIG. 3 is a detailed view of a block of the cascade control.

The invention is described in detail hereinafter with reference to said figures.

FIG. 1 shows a lubricant application device 100 for applying lubricants S1, S2, S3 to the surface of a metal strip 400 in the inlet of a cold rolling stand. The lubricant application device 100 comprises a nozzle beam 110-o with a plurality of nozzles 110-i where i=1-l for applying the lubricant 200 to the upper side of the metal strip 400 and another nozzle beam 110-u, also having a plurality of nozzles, for applying lubricant to the lower side of the metal strip 400. Each individual nozzle 100-i can be adjusted or regulated individually with regard to the amount of lubricant delivered thereby.

In addition to the quantity of delivered lubricant, the respective lubricant composition can also be adjusted individually with the aid of a mixer 150 for each nozzle 110-i. If a plurality of lubricants S1, S2, S3 each having different friction-coefficient varying properties in the rolling gap are provided, the mixer 100 allows a suitable lubricant mixture of the available lubricants S1, S2 and S3 to be combined with a specifically desired property with regard to the friction coefficient in the rolling gap.

The aforementioned possible metering of the applied quantity of lubricant with the aid of nozzles also allows individual nozzles 110-i to be completely switched off. This is particularly advantageous with the outer nozzles of the nozzle beam because by switching on or off, these can be adapted to the width of the rolled metal strip 400 in each case and this can prevent wastage of lubricant.

FIG. 2 illustrates the method forming the basis of the invention for controlling the flatness and/or roughness of a metal strip 400 in the outlet of a cold rolling stand 300 in the form of a control diagram. It can be seen from the diagram that the quantity of lubricant applied to the metal strip is metered in the form of a cascade control with an inner control circuit for the distribution of the applied quantity of lubricant in the width direction, where the desired value for the quantitative distribution Soll-MV is determined or predefined by means of a superposed control circuit.

The inner control circuit comprises a desired/actual value comparator 124, a quantity controller 126 and a control element in the form of a lubricant application device 110 and a quantity detecting device 115 for detecting the amount of lubricant applied to the metal strip 400 by the nozzle beam 110 before the strip enters the cold rolling stand 300. The quantitative distribution Ist-MV over the width of the metal strip 400 thus detected as the actual value is compared in the comparator 124 with a predefined desired quantitative distribution Soll-MV, and the control deviation e_{-MV} resulting from this comparison is fed to the downstream quantity controller 126. The quantity controller, preferably a proportional P-controller, converts the received control deviation e_{MV} into a suitable control signal for triggering the nozzles 110-i of the nozzle beam 110. The quantity controller 126 preferably consists of l individual controllers each individually assigned to a nozzle 110-i of the nozzle beam. These individual controllers can be interlinked by means of a bus. The output signal of the quantity controller 126 in the form of the control signal for the nozzle beam 110 then comprises for its part a plurality of i individual control signals for the individual nozzles 110-i. Naturally, the detection of the quantitative distribution and its regulation with the aid of the inner control circuit is carried out separately for the upper and lower side of the metal strip 400.

The calculations according to the invention of the desired quantity Soll-MV of lubricant applied to the metal strip for the upper or lower side of the metal strip 400 with the aid of the superposed control circuit is explained in detail hereinafter with reference to FIGS. 2 and 3.

The calculations are made in the desired-value calculation device 122 on the basis of a predefined desired flatness distribution Soll-PLV and/or a predefined roughness distribution Soll-RHV. These two predefined desired values are empirical values which are suitably predefined depending on the material of the strip to be rolled in each case. As can be seen from FIG. 3, the desired value for the flatness distribution Soll-PLV is initially compared in a first comparator device 122-1 with an actual value Ist-PLV which represents the flatness distribution of the metal strip 400 at the output of the cold rolling stand 300. The actual value Ist-PLV for the flatness distribution in the width direction of the metal strip is measured with the aid of a flatness sensor device 130-1, e.g. in the form of a flatness measuring roller. The control deviation of the flatness distribution e_{-PLV} is then obtained at the output of the comparator device 122-1. Similarly, the desired value for the roughness distribution Soll-RHV is compared with the relevant actual value Ist-RHV at the outlet of the cold rolling stand 300 in a second comparator device 122-2 so that a control deviation e_{-RHV} is then obtained at the output of the second comparator device 122-2. The actual value Ist-RHV for the roughness distribution in the width distribution of the metal strip is measured with the aid of a roughness sensor device 130-2, e.g. in the form an optical sensor. Depending on the wishes of the user/application, the flatness distribution control deviation and the roughness distribution control deviation can be individually weighted in the calculation of the desired quantitative distribution. For this purpose, the two control deviations are individually weighted in a weighting device 122-3 before they are included in the calculation of the desired quantitative distribution inside the calculation device 122-4.

As can be seen in FIG. 3, in addition to the two weighted control deviations, various characteristics are also included in the calculation of the desired quantitative distribution. These characteristics firstly comprise characteristics P1 specific to the metal strip 400 on the inlet side of the cold rolling stand 300. This is firstly the strip speed on the inlet side (variable) and the width of the metal strip, the material or the alloy of the metal strip and its profiling. Unlike the speed of the metal strip on the inlet side, the three characteristics mentioned subsequently should be regarded as constant within the scope of the present invention. In addition to the characteristics P1 specific to the metal strip, characteristics P2 specific to the rolling stand are also included in the calculation of the desired quantitative distribution which within the scope of the present invention, should all be considered to be constant. These characteristics specific to the cold rolling stand comprise the diameter of the working rollers, its roughness, material and camber. As the third group, mention may be made of the outlet-side characteristics P3, which comprise the flatness distribution of the metal strip, its roughness distribution, strip width, and residual oil content per unit transport length, each measured at the outlet side of the cold rolling stand. As has already been mentioned, the flatness distribution and the roughness distribution are measured as actual values on the outlet side and fed to the comparator device 122-1 or 122-2 individually as variable process parameters. On the other hand, the strip width (assumed to be constant within the scope of the invention) and the residual oil content (measured as a variable process parameter online) are fed to the processor unit 122-4. The two outlet-side characteristics, strip width and residual oil content, are subsequently combined under the designation P3′.

As an intermediate result, it should thus be noted that the desired quantitative distribution for the inner control circuit within the processor unit 122-4 is determined according to the inlet-side characteristics P1, the characteristics specific to the cold rolling stand P2, the outlet-side characteristics P3′ and according to the weighted control deviations for the flatness distribution and the roughness distribution. At the same time, it should be noted that of all said characteristics, only the speed of the metal strip on the inlet side, the two control deviations and the outlet-side residual oil content per unit transport length of the metal strip are time-variable whilst all the other characteristics are considered to be constant with respect to time.

The method according to the invention is now described as an example for several cases:

a) The roughness of the metal strip 400 determined at the outlet of the cold rolling stand 300 deviates from the desired value.

This can mean, for example, that the actual roughness distribution is greater than the corresponding predefined desired value Soll-RHV so that the control deviation of the roughness distribution e_{-RHV} resulting from a comparison of these two quantities is negative. In this example, the flatness distribution should be disregarded so that the negative control deviation for the roughness is fed 100% into the calculation device 124-4. According to the control deviation of the roughness distribution, all the constant parameters and according to the online determined residual oil content on the metal strip on the outlet side of the cold rolling stand 300, the calculation device will then preset a suitable desired quantitative distribution for the inner control circuit so that the roughness distribution in the outlet of the cold rolling stand is reset to the level of the desired roughness distribution in the shortest possible time.

In general, it can be noted that if the roughness is too great, the processor unit 122-4 will change the desired quantitative distribution and thus the amount of lubricant applied on the inlet side according to the negative control deviation of the roughness in order to match the measured roughness distribution on the outlet side to the predefined roughness distribution within a short time.

The manner in which the roughness is influenced by the quantity of lubricant and/or the type of lubricant depends on the general process conditions of the rolling case and is advantageously calculated by a process model.

b) The flatness distribution on the outlet side of the cold rolling stand deviates from the desired flatness distribution.

The manner in which the strip tensile stress distribution and therefore the flatness distribution is influenced by the quantity of lubricant and/or the type of lubricant depends on the general process conditions of the rolling case and is advantageously calculated by a process model.

The criteria of the roughness distribution and the flatness distribution can not only be considered separately but also in parallel and set to respectively predefined desired values. For this it is necessary to suitably adjust the amount of lubricant applied on the inlet side depending on the two control deviations—flatness distribution and roughness distribution.

For each calculation of the desired quantitative distribution within the calculation device 122-4 it holds that the respectively current residual oil content is only taken into account insofar as it is checked within the processor unit 122-4 that the residual oil content firstly does not exceed a predefined upper threshold value for the residual oil content and secondly does not fall below a predefined lower threshold value for the residual oil content. It is important to adhere to the upper threshold to avoid lateral running of the metal strip on a roller table downstream of the cold rolling stand. It is necessary to adhere to the lower threshold to avoid rust formation on the metal strip.

For all applications it holds that a respectively desired change in the friction coefficient in the rolling gap is achieved not only by a change in quantity, but alternatively by means of a change in the composition of the lubricant mixture from the available lubricant components S1, S2 and S3 etc., or by a combination of a change in quantity and change in mixture.

The invention is advantageously used in the last stand of a multiple-stand rolling mill.

1. A method for regulating the flatness of a metal strip (400) in the outlet of a cold rolling stand (300) by suitable metering of the amount of at least one lubricant (200) applied to the metal strip in the form of a quantitative distribution over the width of the metal strip (400) per unit time in the inlet of the cold rolling stand, wherein the metering is effected according to a detected control deviation (e_{-RHV}) between an actual and a desired roughness distribution over the width of the metal strip (400) in the outlet of the cold rolling stand.

2. A method for regulating the flatness of a metal strip (400) in the outlet of a cold rolling stand (300) by suitable metering of the amount of at least one lubricant (200) applied to the metal strip in the form of a quantitative distribution over the width of the metal strip (400) per unit time in the inlet of the cold rolling stand, according to a detected control deviation (e_{-PLV}) between an actual and a desired flatness distribution over the width of the metal strip (400) in the outlet of the cold rolling stand; wherein the metering is additionally effected according to a detected control deviation (e_{-RHV}) between an actual and a desired roughness distribution over the width of the metal strip (400) in the outlet of the cold rolling stand (300).

3. A method for regulating the roughness of a metal strip (400) in the outlet of a cold rolling stand (300) by suitable metering of the amount of at least one lubricant (200) applied to the metal strip in the inlet of the cold rolling stand per unit time, wherein the applied amount of lubricant (200) is metered in the form of a quantitative distribution over the width of the metal strip (400) per unit time according to a detected control deviation (e_{-PLV}) between an actual and a desired flatness distribution over the width of the metal strip (400) in the outlet of the cold rolling stand or according to a control deviation (e_{-RHV}) between an actual and a desired roughness distribution over the width of the metal strip (400) in the outlet of the cold rolling stand (300) or a combination of both control deviations.

4. The method according to claim 1, wherein the quantity of applied lubricant (200) is varied in a range of 1-20 ml/minute/100 mm width of the metal strip (400).

5. The method according to claim 1, wherein the quantity is metered in the form of a cascade control with an inner control circuit for the applied quantitative distribution, wherein the desired value for the quantitative distribution (Soll-MV) is determined with the aid of a superposed control circuit on the basis of individual, a plurality of or all the characteristics from the groups of inlet-side (P1), cold-rolling-frame specific (P2) and outlet-side (P3) characteristics and according to the detected control deviation (e_{-PLV}) between the actual and the desired flatness distribution, the control deviation (e_{-RHV}) between the actual and the desired roughness distribution or a combination of the two control deviations.

6. The method according to claim 5, wherein the group of inlet-side characteristics (P1) of the metal strip (400) comprises: its speed there, its width there, its material and its profiling there.

7. The method according to claim 5, wherein the group of cold-rolling-stand specific characteristics (P2) comprises: the working roller diameter, the working roller roughness, the material of the working rollers and the camber of the working rollers.

8. The method according to claim 5, wherein the group of outlet-side characteristics (P3) of the metal strip (400) comprises: its speed there, its width there, the residual content of lubricant on its surface per unit length in the direction of transport, its flatness distribution in the width direction there and its roughness distribution in the width direction there.

9. The method according to claim 8, wherein an upper and/or a lower threshold value for the residual content of lubricant on the outlet side is predefined.

10. The method according to claim 5, wherein at the beginning of the method for the first determination of the desired value for the quantitative distribution, the actual flatness distribution and the actual roughness distribution are each pre-adjusted to a suitable initial value, for example to zero.

11. The method according to claim 1, wherein the metal strip (400) is only cooled on the outlet side but not on the inlet side of the cold rolling stand.

12. The method according to claim 1, wherein a plurality of lubricants (S1, S2, S3) each having a different friction-coefficient lowering effect in the rolling gap of the cold rolling stand (300) are available and the metering of the quantitative distribution of the lubricant (200) applied to the metal strip per unit time and over the width of the metal strip is effected by a suitable mixture of the available lubricants (S1, S2, S3) amongst one another and with air with regard to a desired friction coefficient in the rolling gap.

13. The method according to claim 1, wherein the metal strip (400), for example, comprises a steel or a nonferrous metal strip, e.g. an aluminium strip.

14. The method according to claim 1, wherein the magnitude of the rolling gap of the cold rolling stand is kept constant during the total processing time of the metal strip (400).

15. The method according to claim 1, wherein in the inlet of the cold rolling stand, the lubricant is applied to the upper and/or lower side of the metal strip and/or to at least one working roller of the cold rolling stand.

16. A computer program with a program code for a control device (120) of a lubricant application device (100) wherein the program code is configured for carrying out the method according to claim 1.

17. A data carrier with a computer program according to claim 16.

18. A lubricant application device (100) comprising:
a container (160) for at least one lubricant (S1, S2, S3);
at least one nozzle beam (100) with a plurality of nozzles (110-i), wherein the nozzle beam is arranged at the inlet side of a cold rolling stand (300) transverse to the direction of transport of a metal strip (400) for metering the lubricant (S1, S2, S3) on the metal strip per unit time; and
a control device (120) for suitable controlling of the nozzles (110-i) of the nozzle beam (110) with regard to a desired flatness of the metal strip; wherein a roughness sensor device (130-2) is provided on the outlet side for detecting the actual roughness distribution there over the width of the metal strip (400); and
the control device (120) is configured in cooperation with the nozzle beam (110) to meter the at least one lubricant (S1, S2, S3) distributed quantitatively over the width of the metal strip (400) and per unit time according to a control deviation (e_{-RH}) between the actual and the desired roughness distribution over the width of the metal strip (400) in the outlet of the cold rolling stand.

19. A lubricant application device (100) comprising:
a container (160) for at least one lubricant (S1, S2, S3);
at least one nozzle beam (100) with a plurality of nozzles (110-i), wherein the nozzle beam is arranged at the inlet side of a cold rolling stand (300) transverse to the direction of transport of a metal strip (400) for metering the lubricant (S1, S2, S3) on the metal strip per unit time;
a flatness sensor device (130-1) is provided on the outlet side of the cold rolling stand (300) for detecting the actual flatness distribution there over the width of the metal strip; and
the control device (120) is configured in cooperation with the nozzle beam (110) to meter the at least one lubricant (S1, S2, S3) distributed quantitatively over the width of the metal strip (400) and per unit time according to a control deviation (e_{-PLV}) between the actual and the desired flatness distribution over the width of the metal strip (400) in the outlet of the cold rolling stand with regard to a desired flatness of the metal strip; wherein a roughness sensor device (130-2) is provided on the outlet side of the cold rolling stand (300) for detecting the actual roughness distribution there over the width of the metal strip (400); and
the control device is configured to meter the lubricant with regard to the desired flatness additionally according to a control deviation (e_{-RH}) between the actual and a desired roughness distribution over the width of the metal strip (400) in the outlet of the cold rolling stand (300).

20. A lubricant application device (100) comprising:
a container (160) for at least one lubricant (S1, S2, S3);
at least one nozzle beam (100) with a plurality of nozzles (110-i), wherein the nozzle beam is arranged at the inlet side of a cold rolling stand (300) transverse to the direction of transport of a metal strip (400) for metering the lubricant (S1, S2, S3) on the metal strip per unit time;
a control device (120) for suitably controlling the nozzles (110-i) of the nozzle beam (110) with regard to a desired roughness of the metal strip; wherein a flatness sensor device (130-1) is provided on the outlet side of the cold rolling stand (300) for detecting the actual flatness distribution there over the width of the metal strip and/or a roughness sensor device (130-2) is provided on the outlet side of the cold rolling stand (300) for detecting the actual roughness distribution there over the width of the metal strip (400); and
the control device (120) is configured in cooperation with the nozzle beam (110) to meter the at least one lubricant (S1, S2, S3) distributed quantitatively over the width of the metal strip (400) and per unit time according to a control deviation (e_{-PLV}) between the actual and the desired flatness distribution over the width of the metal strip (400) in the outlet of the cold rolling stand (300) or a control deviation (e_{-RH}) between the actual and a desired roughness distribution over the width of the metal strip (400) in the outlet of the cold rolling stand or a combination of both control deviations.

21. The lubricant application device (100) according to
a container (160) for at least one lubricant (S1, S2, S3);
at least one nozzle beam (100) with a plurality of nozzles (110-i), wherein the nozzle beam is arranged at the inlet side of a cold rolling stand (300) transverse to the direction of transport of a metal strip (400) for metering the lubricant (S1, S2, S3) on the metal strip per unit time; and
a control device (120) for suitable controlling of the nozzles (110-i) of the nozzle beam (110) with regard to a desired flatness of the metal strip; wherein a roughness sensor device (130-2) is provided on the outlet side for detecting the actual roughness distribution there over the width of the metal strip (400); and
the control device (120) is configured in cooperation with the nozzle beam (110) to meter the at least one lubricant (S1, S2, S3) distributed quantitatively over the width of the metal strip (400) and per unit time according to a control deviation (e_{-RH}) between the actual and the desired roughness distribution over the width of the metal strip (400) in the outlet of the cold rolling stand, wherein the lubricant application device is configured to carry out the method according to claim 1.
